(19) United States
(12) Patent Application Publication
(10) Pub. No.: US 2014/0075290 A1
(43) Pub. Date: Mar. 13, 2014

(54) WINDOW SWITCHING METHOD AND APPARATUS

(71) Applicant: Tencent Technology (SHENZHEN) Company Limited, Shenzhen (CN)

(72) Inventors: SHI ZHEN, Shenzhen (CN); XIMIN YU, Shenzhen (CN); FENG WANG, Shenzhen (CN); MINGLI DONG, Shenzhen (CN); YINGHUA YE, Shenzhen (CN); MEINUO LI, Shenzhen (CN)

(73) Assignee: Tencent Technology (SHENZHEN) Company Limited, Shenzhen (CN)

(21) Appl. No.: 14/077,402

(22) Filed: Nov. 12, 2013

Related U.S. Application Data
(63) Continuation of application No. PCT/CN2013/082452, filed on Aug. 28, 2013.

(30) Foreign Application Priority Data
Aug. 29, 2012 (CN) 201210312379.0

(51) Int. Cl. G06F 17/22

(52) U.S. Cl. CPC G06F 17/2247
USPC 715/234

(57) ABSTRACT

A window switching method is provided. When the browser receives information that a user needs to switch a webpage displayed in the current window, the browser obtains all currently opened webpages. The browser creates multiple display areas for all currently opened webpages based on preset rules and displays topic content of each visible webpage in the corresponding display area in a current window. When the browser receives a command that the user selects one of the display areas, the browser displays the currently opened webpage corresponding to the selected display area in the current window.

### CROSS-REFERENCES TO RELATED APPLICATIONS

This application is a continuation of PCT Patent Application No. PCT/CN2013/082452, filed on Aug. 28, 2013, which claims priority of Chinese Patent Application No. 201210312379.0, filed on Aug. 29, 2012, the entire contents of all of which are incorporated by reference herein.

### FIELD OF THE INVENTION

The present invention generally relates to computer network technologies and, more particularly, to window switching methods and apparatus.

### BACKGROUND

With the rapid development of computer network technology, more and more users connect to the Internet through mobile terminals on various occasions. Window switching via tabs is commonly used in traditional computer browsers. However, for terminals with small size screen, it is not convenient to switch between windows through tabs when a user uses the browser. Therefore, other types of window switching methods adaptive to terminals with small size screen (i.e., mobile phone) are needed.

Certain window switching technologies have been developed for use in terminals with small size screen, such as mobile phones. One of such technologies is to switch windows through a sliding screen. When using this method, the terminal screen only displays one window each time. The user can view each window currently opened in the browser by sliding the screen to the left or to the right. Then, the user may click on the window to switch it to be the current window. However, this method has following limitations: only one window is displayed in the terminal for the user to select each time; and the efficiency of switching between multiple windows is relatively low.

Another of such existing technologies is to switch windows through a list. Each unit in the list includes a headline and a Universal Resource Locator (URL) corresponding to the headline. Clicking on an entry of the list switches the selected contents to the target window for the user to view. The limitations of this method are: the window can only be distinguished by the headline and the URL, if the headline is too long, it may be difficult for the user to identify the webpage to be displayed.

The disclosed method and apparatus are directed to solve one or more problems set forth above and other problems.

### BRIEF SUMMARY OF THE DISCLOSURE

One aspect of the present disclosure includes a window switching method. When the browser receives information that a user needs to switch a webpage displayed in the current window, the browser obtains all currently opened webpages. The browser creates multiple display areas for all currently opened webpages based on preset rules and displays topic content of each visible webpage in the corresponding display area in a current window. When the browser receives a command that the user selects one of the display areas, the browser displays the currently opened webpage corresponding to the selected display area in the current window.

Another aspect of the present disclosure includes a window switching apparatus. The apparatus includes a starting module, a processing module, and a selection module. The starting module is configured to obtain all currently opened webpages when a browser receives information that a user needs to switch the webpage displayed in a current window. The processing module is configured to create multiple display areas for all currently opened webpages based on preset rules and display topic content of each webpage in the corresponding display area. The selection module is configured to display the currently opened webpage corresponding to the selected display area in the current window when the browser receives a command that the user selects one of the display areas.

Other aspects of the present disclosure can be understood by those skilled in the art in light of the description, the claims, and the drawings of the present disclosure.

### BRIEF DESCRIPTION OF THE DRAWINGS

The exemplary embodiments of the present invention are described in detail by referring to the accompanying drawings, such that those skilled in the art can understand the features and advantages of the present invention. In the accompanying drawings:

FIG. 1 illustrates a flow diagram of an exemplary window switching method consistent with the disclosed embodiments;

FIG. 2 illustrates a flow diagram of another exemplary window switching method consistent with the disclosed embodiments;

FIG. 3 illustrates a schematic diagram of an exemplary window switching interface consistent with the disclosed embodiments;

FIG. 4 illustrates a schematic diagram of another exemplary window switching interface consistent with the disclosed embodiments;

FIG. 5 illustrates a flow diagram of another exemplary window switching method consistent with the disclosed embodiments;

FIG. 6 illustrates a schematic diagram of another exemplary window switching interface consistent with the disclosed embodiments;

FIG. 7 illustrates a schematic diagram of another exemplary window switching interface consistent with the disclosed embodiments;

FIG. 8 illustrates a structure diagram of an exemplary window switching apparatus consistent with the disclosed embodiments;

FIG. 9 illustrates a structure diagram of an exemplary processing module consistent with the disclosed embodiments;

FIG. 10 illustrates a structure diagram of an exemplary creating unit consistent with the disclosed embodiments;

FIG. 11 illustrates a structure diagram of an exemplary display unit consistent with the disclosed embodiments;

FIG. 12 illustrates a structure diagram of another exemplary display unit consistent with the disclosed embodiments;

FIG. 13 illustrates a structure diagram of an exemplary selection module consistent with the disclosed embodiments;

FIG. 14 illustrates an exemplary operating environment incorporating certain disclosed embodiments; and

FIG. 15 illustrates a block diagram of an exemplary computer system capable of implementing terminal, client, and/or cloud server.

### DETAILED DESCRIPTION

Reference will now be made in detail to exemplary embodiments of the invention, which are illustrated in the accompanying drawings.

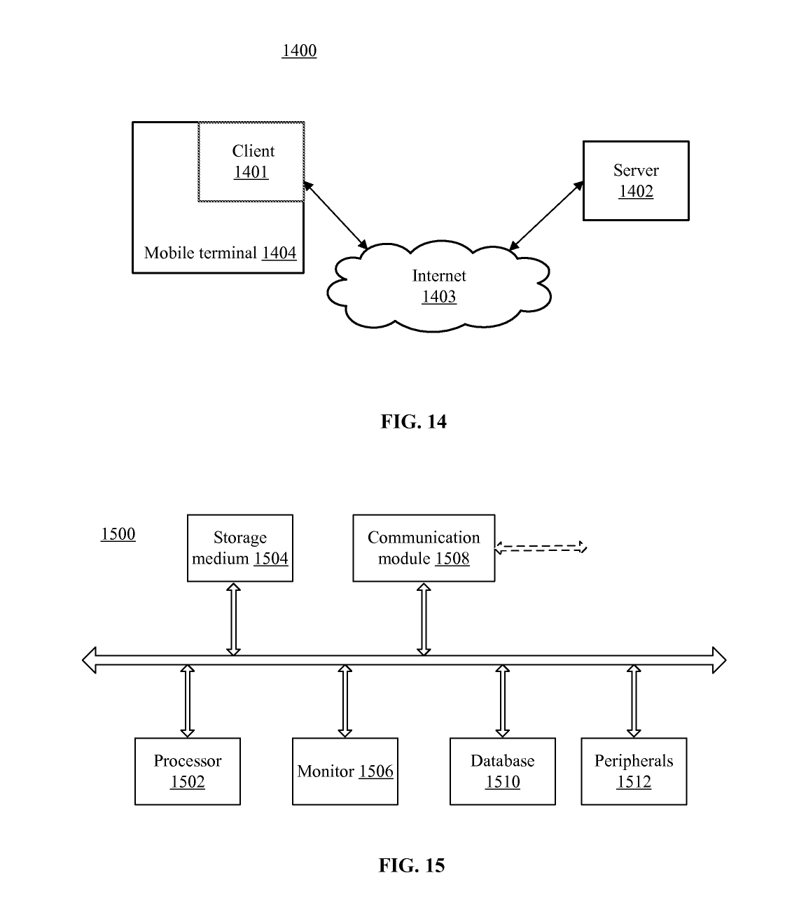

FIG. 14 illustrates an exemplary operating environment 1400 incorporating certain disclosed embodiments. As shown in FIG. 14, environment 1400 may include a mobile terminal 1404, the Internet 1403, and a server 1402. The Internet 1403 may include any appropriate type of communication network for providing network connections to the mobile terminal 1404 and server 1402 or among multiple terminals 1404 and servers 1402. For example, Internet 1403 may include the Internet or other types of computer networks or telecommunication networks, either wired or wireless.

A server, as used herein, may refer to one or more server computers configured to provide certain web server functionalities to provide certain personalized services, which may require any user accessing the services to authenticate to the server before the access. A web server may also include one or more processors to execute computer programs in parallel.

The server 1402 may include any appropriate server computers configured to provide certain server functionalities, such as a web server functionality for responding a user's request for web page operations or other application server. Although only one server is shown, any number of servers 1402 can be included. The server 1402 may be operated in a cloud or non-cloud computing environment.

Mobile terminal 1404 may include any appropriate type of mobile computing device, such as a mobile phone, a smart phone, a tablet, a notebook computer, or any type of mobile computing platform. Mobile terminal 1404 may include one or more clients 1401. The client 1401, as used herein, may include any appropriate mobile application software, hardware, or a combination of application software and hardware to achieve certain client functionalities. For example, client 1401 may include a browser, etc. According to actual needs in different terminals, a mobile client may be a browser installed in terminal for browsing, including various types of existing and future browser installed in mobile terminals. Although only one client 1401 is shown in the environment 1400, any number of clients 1401 may be included.

Mobile terminal 1404, client 1401, and/or server 1402 may be implemented on any appropriate computing platform. FIG. 15 illustrates a block diagram of an exemplary computer system 1500 capable of implementing mobile terminal 1404, client 1401, and/or server 1402.

As shown in FIG. 15, computer system 1500 may include a processor 1502, a storage medium 1504, a monitor 1506, a communication module 1508, a database 1510, and peripherals 1512. Certain devices may be omitted and other devices may be included.

Processor 1502 may include any appropriate processor or processors. Further, processor 1502 can include multiple cores for multi-thread or parallel processing. Storage medium 1504 may include memory modules, such as ROM, RAM, flash memory modules, and erasable and rewritable memory, and mass storages, such as CD-ROM, U-disk, and hard disk, etc. Storage medium 1504 may store computer programs for implementing various processes, when executed by processor 1502.

Further, peripherals 1512 may include I/O devices such as keyboard and mouse, and communication module 1508 may include network devices for establishing connections through the communication network. Database 1510 may include one or more databases for storing certain data and for performing certain operations on the stored data, such as database searching.

In operation, client 1401 and server 1402 may interact with each other to provide a web browsing service to the user(s) of the client 1401. Because a mobile browser often has a limited display area, general computer-based browser technology may be unsuitable for the mobile browser.

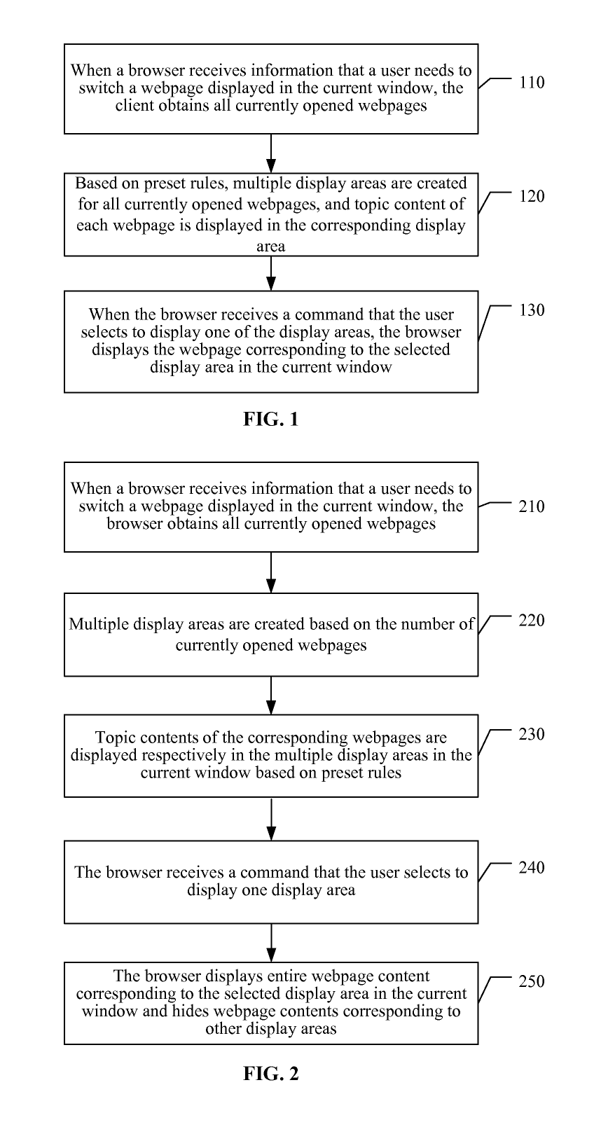

FIG. 1 illustrates a flow diagram of an exemplary window switching method consistent with the disclosed embodiments. As shown in FIG. 1, the method includes the following steps:

Step 110: when a browser receives information that a user needs to switch a webpage displayed in the current window, the client (e.g., a mobile browser) obtains all currently opened webpages.

Step 120: based on preset rules, multiple display areas are created for all currently opened webpages, and the topic content of each webpage is displayed in the corresponding display area.

Step 130: when the browser receives a command that the user selects to display one of the display areas, the browser displays the webpage corresponding to the selected display area in the current window.

When a browser receives information that a user needs to switch webpages in the current window, the browser obtains all currently opened webpages. Based on preset rules, multiple display areas are created for all opened webpages, and topic content of each webpage in the corresponding display area is displayed. When receiving a command that the user selects to display one of the display areas, the browser displays the webpage corresponding to the selected display area in the current window. Thus, when browsing multiple websites in the current window, the user may more visually and directly determine the webpage that is desired to browse and switch between webpages quickly, greatly improving the efficiency of window switching.

FIG. 2 illustrates a flow diagram of another exemplary window switching method consistent with the disclosed embodiments. As shown in FIG. 2, the method includes the following steps:

Step 210: when a browser receives information that a user needs to switch a webpage displayed in the current window, the browser obtains all currently opened webpages.

Specifically, when a browser receives information that a user needs to switch the webpage displayed in the current window to browse other webpages, the browser obtains all currently opened webpages, including the webpage that is displayed in the current window.

Then, based on preset rules, multiple display areas are created for all currently opened webpages, and topic content of the corresponding webpages are displayed in the multiple display areas, respectively.

Because mobile terminals with small size screen, i.e. mobile phone, may be unable to switch the visited windows by a similar tab mode used in computer browsers, an interface that can place multiple windows or alternative forms of multiple windows for switching in the current window is generated. This interface is generally called multi-window. As used herein, the multi-window interface refers to multiple display areas that are created in a new window for all currently opened webpages. Each display area displays corresponding webpage content, respectively.

Step 220: multiple display areas are created based on the number of currently opened webpages.

During the process of creating display areas for all webpages being visited, the current window of mobile terminal screen is divided horizontally or vertically, and display specification of each display area is obtained. Due to reading habit, horizontal division is used here, that is, display specification of each display area is obtained by setting the height value of each display area. Multiple display areas are created based on the display specifications. The number of display areas that are created corresponds to the number of webpages that are currently opened.

As the size of the current window is limited and webpage contents need to be displayed clearly, setting the number of display areas that are allowed to be displayed in the window (a display threshold number) is needed to ensure clarity of the display. The display threshold number refers to the number of display areas that are allowed to be displayed in the window. During the process of creating multiple display areas, the current window is divided horizontally/vertically based on either the number of currently opened webpages (when the number of currently opened webpages is less than the display threshold number) or the threshold number (when the number of currently opened webpages is greater than or equal to the threshold number).

If the number of currently opened webpages is greater than or equal to the number of display areas that are allowed to be displayed in the current window (the display threshold number), the current window is divided horizontally/vertically based on the display threshold number, and the display specification of each allowed display area is obtained. Then, multiple display areas are created based on the number of currently opened webpages and the display specification of each allowed display area. The number of display areas that are created equals to the number of currently opened webpages, although the current window can only display a number of display areas by the display threshold number (i.e., visible display areas).

For example, the number of currently opened webpages is 6, and the number of display areas that are allowed to be displayed in the window is 4, based on the number of display areas that are allowed to be displayed in the window, the current window is horizontally divided by 4 to obtain the display specification of each display area. The structure label height of each display area is set to 25% of the height of the current window. Then, six display areas are created based on the display specifications.

If the number of currently opened webpages is less than the number of display areas that are allowed to be displayed in the current window (the display threshold number), the current window is divided horizontally/vertically based on the number of currently opened webpages, and the display specification of each display area is obtained. That is, multiple display areas are created based on the number of currently opened webpages and the obtained display specification of each display area. The number of display areas that are created equals to the number of currently opened webpages (i.e., all display areas are visible).

Specifically, if the number of currently opened webpages is less than the number of display areas that are allowed to be displayed in the current window, the created display areas may be enlarged appropriately (with respect to the areas based on the display threshold number). For example, when the number of currently opened webpages is 3, and the number of display areas that are allowed to be displayed in the current window is 4, based on the number of currently opened webpages, the current window is horizontally divided by 3 and the display specification of each display area is obtained. The structure label height of each display area is set to 33% of the height of the current window. Then, three display areas are created based on the display specifications.

Step 230: topic contents of the corresponding webpages are displayed in the multiple visible display areas in the current window based on preset rules, respectively.

The multiple visible display areas are displayed in the current window. Each display area, as part of the current window, displays topic content of the corresponding webpage. The webpage content within the scope of its display area and the title together constitute topic content.

Specifically, each window that is currently visited renders the webpage content based on URLs. Because area size of the display area restricts the web content displayed in the subwindow, the webpage content is displayed partially to adapt to the scope of the display area. Because the display areas are created using a horizontal division rule in advance, the length, the width and the position relationship for displaying the web content may be defined by setting the window structure tag within the subwindow.

Pixel value from display of the subwindow to the top of the screen is set as top. Pixel value from display of the subwindow to the left of the screen is set as left. The height of the subwindow is height, and the width of the subwindow is width. Because the webpages of mobile phones generally show the site name and title directory in the upper left corner, the parameters for displaying structure label in the subwindow may be set to top=0 and left=0. Because the current window is horizontally divided, the width is 100%, whereas the height parameter is determined based on the preset number of division parameters.

If four display areas are created in one screen and the height of each display area is set as 25% of the height of the current window, the height of the subwindow may be set to 21% to 23% of the height of the current window, and the height of the identification in the display area may be set to 4%˜2% of the height of the current window. That is, each subwindow corresponds to a rendered webpage. when the subwindow in each display area of the window only displays the webpage content within the setting scope, the display of the subwindow is set to normal width and 21%˜23% of the height of the current window, and the position of the webpage is in the upper left corner.

The identification corresponding to the webpage content may also be placed at the bottom of the display area, such as a title, a logo, a URL. The structure tag in the display area allocates certain range display area to display the related title, logo, URL, etc. For example, a narrow strip area in the lower part of each display area is allocated separately to display the related title, logo, URL, etc. With such key information, the user can locate the needed window more conveniently, more clear and intuitive. Each display area may also include a close button. The user can close the window that is not needed more quickly.

The subwindow of the display area displays topic content of the corresponding page, ensuring the unification of imagery for selecting window and accuracy for switching window based on the content. The use of the screen is maximized to ensure that the use of display resource of the small screen terminal is maximized.

The number of created display areas that are displayed in the current window may be either the display threshold number (when the number of currently opened webpages is greater than the display threshold number) or the number of currently opened webpages (when the number of currently opened webpages is less than or equal to the display threshold number).

If the number of currently opened webpages is greater than the number of display areas that are allowed to be displayed in the window (the display threshold number), webpage contents and/or titles corresponding to the display areas that are allowed to be displayed are displayed respectively in the window, and webpage contents and/or titles corresponding to other display areas are hidden.

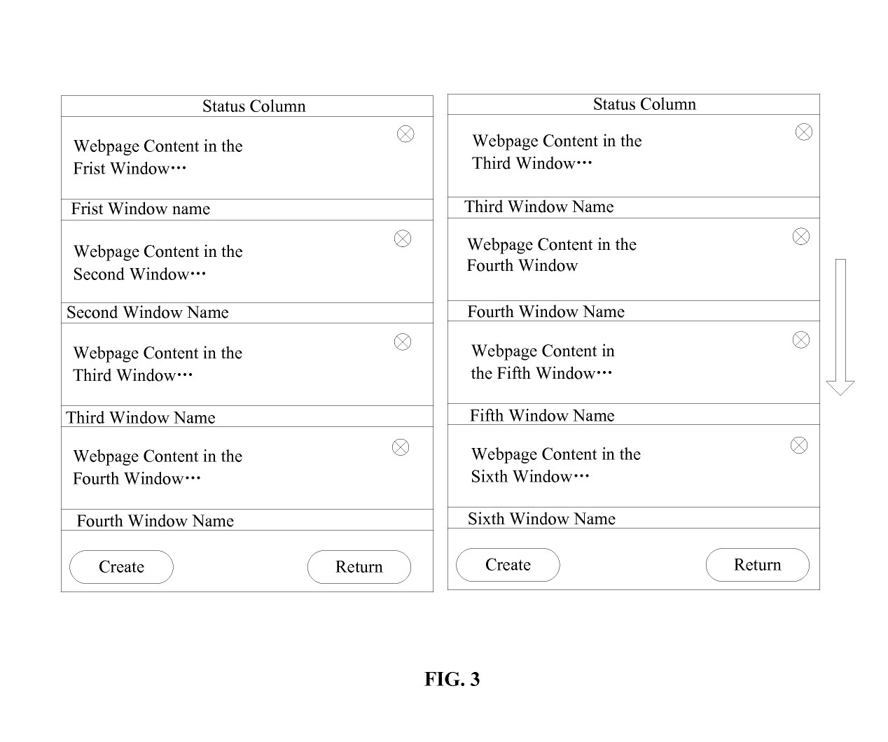

When the browser displays webpages, if the number of currently opened webpages is greater than the number of display areas that are allowed to be displayed in the window, webpage contents and/or titles corresponding to the display areas that are allowed to be displayed are displayed respectively, and webpage contents and/or titles corresponding to other display areas are hidden. For example, the number of display areas that are allowed to be displayed in a horizontally created window is set to 4, and the number of currently opened webpages is 6. FIG. 3 illustrates a schematic diagram of an exemplary window switching interface consistent with the disclosed embodiments. As shown in the left half part of FIG. 3, the display height of the window is set to “25%, 25%, 25%, 25%” in the first four display areas, and the webpage contents and/or titles corresponding to the first four display areas are displayed in subwindows, respectively. The webpage contents and/or titles corresponding to the fifth display area and the sixth display area are hidden.

If the number of currently opened webpages is less than or equal to the number of display areas that are allowed to be displayed (the display threshold number), web contents and/or titles corresponding to the all display areas are displayed, respectively.

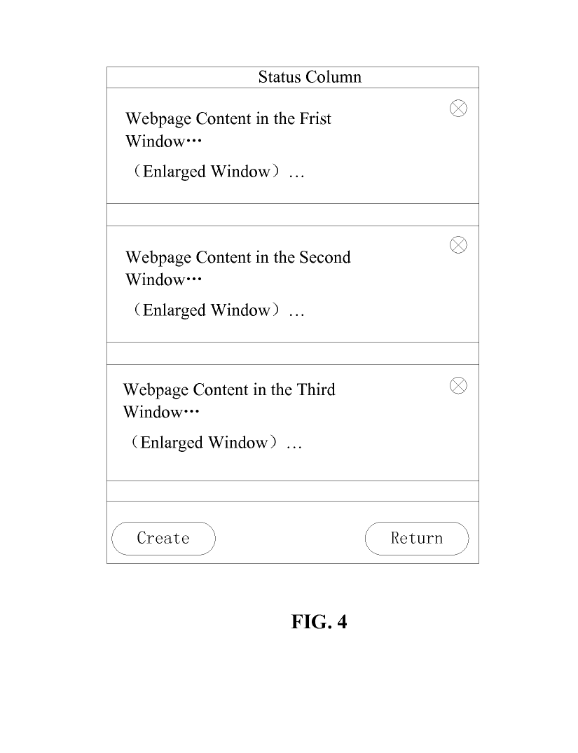

When the browser displays webpages, if the number of currently opened webpages is less than or equal to the number of display areas that are allowed to be displayed in the window, webpage contents and/or titles corresponding to all display areas are displayed respectively in the display areas. For example, the number of display areas that are allowed to be displayed in a horizontally created window is set to 4, and the number of currently opened webpages is 3. FIG. 4 illustrates a schematic diagram of another exemplary window switching interface consistent with the disclosed embodiments.

As shown in FIG. 4, the three webpages are displayed, respectively. The display height of the windows is set respectively to “33%, 33%, 33%” in the three display areas, and the webpage contents and the titles corresponding to the first display area, the second display area and the third display area are displayed in subwindows of the display area, respectively.

In addition, if the number of currently opened webpages is greater than the number of display areas that are allowed to be displayed in the window (display threshold number), some display areas and the corresponding webpage contents are hidden. A terminal may receive a command that the user selects to display one of the hidden areas. Thus, the webpage content and/or the title corresponding to requested hidden display area are displayed in the current window.

Specifically, for the webpage contents corresponding to the hidden display areas and their subwindow, the user may display arbitrarily the webpage content and/or the title corresponding to the display area displayed in the current window to the webpage content and/or the title corresponding to the hidden display area by a sliding screen mode, a drag mode, etc. As used herein, the user uses a side roller to slide longitudinally the screen. As shown in the right half part of FIG. 3, when the user slides the screen longitudinally, the screen displays the hidden display areas and hides the previously displayed display areas. That is, the webpage contents and/or the titles corresponding to the first two display areas (the first display area and the second display area) are hidden, and the webpage contents and/or the titles corresponding to the last two display areas (the fifth display area and the sixth display area) are displayed. In addition, if the user exits the display area of the current screen, remaining hidden display areas may fill the spare display areas.

Finally, when receiving a command that the user selects one display area, the webpage corresponding to the selected display area is displayed in the current window. The window switching method further includes the following steps:

Step 240: the browser receives a command that the user selects to display one display area.

By browsing the display and identification information of the webpage contents in the display areas, the user may quickly find the display area with the webpage content that needs to be browsed. As used herein, the browser receives the command that the user selects to display one display area by receiving clicking from the user in the display area. The browser may also receive the command by receiving sliding, dragging and voice selection from the user. There is no specific limitation here.

Step 250: the browser displays entire webpage content corresponding to the selected display area in the current window and hides webpage contents corresponding to other display areas.

Because the display area is created horizontally, after the browser confirms that the user selects a display area, the window of the selected display area is enlarged by changing the height of the display area to form a new current window, that is, longitudinal expansion. The browser displays the entire webpage content of the selected display area in the normal display mode and hides other displays areas displayed in the window. In general, the new window displays the webpage content in a full-screen mode, thus the user may browse the window more conveniently. The effects during the process of hiding other display areas, such as stretch, fly in and blinds may be set by related effect tags. There is no specific limitation here.

When a browser receives information that a user needs to switch a webpage displayed in the current window, the browser obtains all currently opened webpages. Based on the number of webpages, multiple display areas are created for all currently opened webpages. The webpage content of each webpage that is visited is partially displayed in subwindow based on the scope of the display area. The method takes into account the imagery of webpage content and the efficiency of the webpage selection. Thus, the user may quickly determine the window that needs to be browsed. After browsing webpage contents of the subwindows of the display areas, the user selects a display area. The browser receives the selection command and enlarges the selected display area to form a new current window, and other display areas are hidden. The newly formed current window displays the webpage content in normal size. Comparing to webpage selection by the list, the user may switch between windows more quickly and accurately based on webpage content rather than only the title when using terminals with small size screen. Comparing to webpage selection by sliding screen, the user does not need to repeat the operations when the webpages are not adjacent. A smooth loop interface with the current window-multiple subwindows-new current window is formed, improving the efficiency for switching windows.

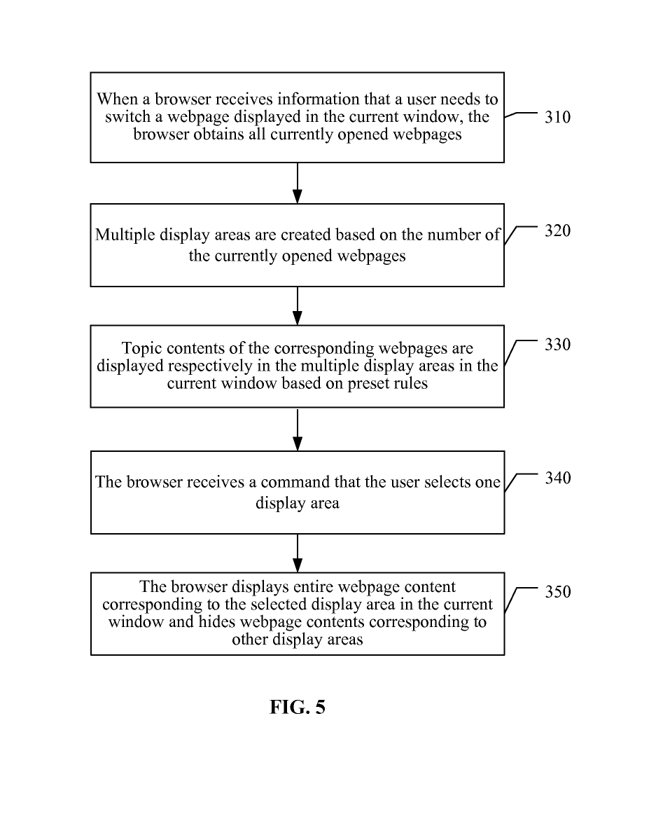

FIG. 5 illustrates a flow diagram of another exemplary window switching method consistent with the disclosed embodiments. Step 310, Step 320 and Step 340 in FIG. 5 are similar to Step 210, Step 220, and Step 240 described in FIG. 2. As shown in FIG. 5, the method includes the following steps:

Step 310: when a browser receives information that a user needs to switch a webpage displayed in the current window, the browser obtains all currently opened webpages. Then, based on preset rules, multiple display areas are created for all currently opened webpages, and topic content of the corresponding webpages are displayed in the multiple display areas, respectively.

Because mobile terminals with small size screen, i.e. mobile phone, may be unable to switch the visited windows by a similar tab mode used in computer browsers, an interface that can place multiple windows or alternative forms of multiple windows for switching in the current window is generated. This interface is generally called multi-window. As used herein, the multi-window interface refers to multiple display areas that are created in a new window for all currently opened webpages. Each display area displays the corresponding webpage content, respectively.

Step 320: multiple display areas are created based on the number of currently opened webpages.

During the process of creating multiple display areas, the current window is divided horizontally/vertically based on either the number of currently opened webpages (when the number of currently opened webpages is less than the display threshold number) or the display threshold number (when the number of currently opened webpages is greater than or equal to the threshold number).

If the number of currently opened webpages is less than the number of display areas that are allowed to be displayed in the current window (the display threshold number), based on the number of currently opened webpages, the current window is divided horizontally/vertically to obtain the display specification of each display area. Multiple display areas are created based on the number of currently opened webpages and the display specification of each display area. The number of display areas that are created equals to the number of currently opened webpages. The created display areas may be enlarged appropriately.

If the number of currently opened webpages is greater than or equal to the number of display areas that are allowed to be displayed in the current window (the display threshold number), based on the number of display areas that are allowed to be displayed in the current window, the current window is divided horizontally/vertically to obtain the display specification of each display area. Multiple display areas are created based on the number of currently opened webpages and the display specification of each display area. The number of display areas that are created equals to the number of currently opened webpages, while the number of visible display areas equals to the number allowed to be displayed.

Step 330: topic contents of the corresponding webpages are displayed in the multiple display areas in the current window based on specifications of the currently opened webpages, respectively.

The visible multiple display areas are displayed in the current window, respectively. Each display area, as part of the current window, displays topic content of the corresponding webpage. The webpage content within the setting scope and the title together constitute topic content.

As used herein, each window that is currently visited renders the webpage content based on URLs. Due to restriction of the scope of the display areas in the multi-window interface, the webpage content needs to be partially displayed to some extent as limited by the display area. Because the display areas are created using a horizontal division rule in advance, the scope of the webpage adaptive to the display area should be captured, that is, the horizontal rectangular shaped area. Specifically, the webpage content in the upper left corner is captured by setting coordinates of the screenshot of the current webpage window. In FIG. 3, the actual area of left upper corner webpage content that is not larger than the scope of the display area is displayed in the display area. The contents displayed in the display area may be proportionally captured webpage content adaptive to the scope of the display area.

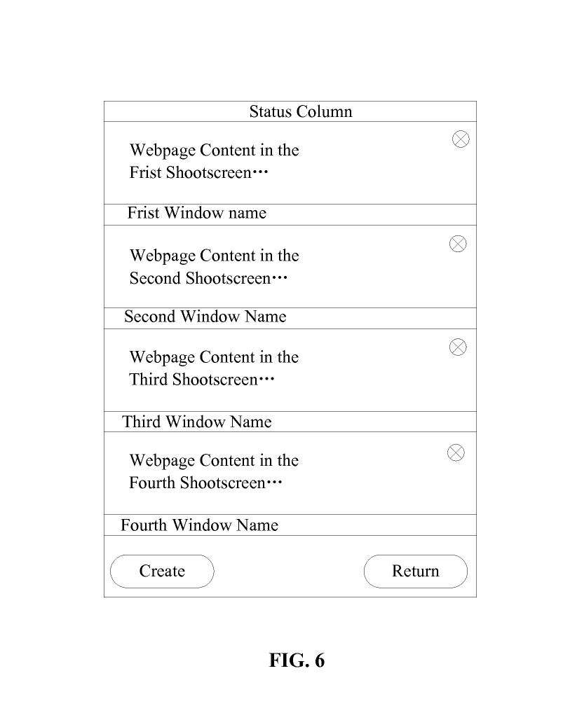

Specifically, the selected area of webpage content may be captured in a one-to-one ratio taken from a screenshot of the webpage. FIG. 6 illustrates a schematic diagram of another exemplary window switching interface consistent with the disclosed embodiments. As shown in FIG. 6, the display effect of the screen is basically the same as the display effect described in FIG. 3. The user may also zoom in or out on each screenshot in each display area of the current screen.

FIG. 7 illustrates a schematic diagram of another exemplary window switching interface consistent with the disclosed embodiments. When the screenshot that is larger than the display area is zoomed out, as shown in the right part of FIG. 7, the screenshot displayed in the multiple windows may intercept visually information contained in the whole webpage. For example, the user may zoom out to display the entire webpage content.

When the screenshot that is smaller than the display area is zoomed in, as shown in the left part of FIG. 7, the webpage content is displayed in the display area more clearly. For example, when a news headline font displayed in the original page is relatively small, after this step is performed, a user with poor vision may intuitively and accurately acquires news headlines. The screenshot is captured according to actual situations. The browser may capture and display the screenshot in a one-to-one ratio, zoom out on the screenshot that is larger than the display area, and zoom in on the screenshot that is smaller than the display area. The ratio for zooming out on the screenshot that is larger than the display area, or zooming in on the screenshot that is smaller than the display area is determined based on practical engineering experience, without specific limitations.

The number of created display areas that are displayed in the current window may be either the display threshold number (when the number of currently opened webpages is greater than the display threshold number) or the number of currently opened webpages (when the number of currently opened webpages is less than or equal to the display threshold number).

If the number of currently opened webpages is greater than the number of display areas that are allowed to be displayed in the current window (the display threshold number), webpage contents and/or the titles corresponding to the display areas that are allowed to be displayed are displayed respectively in the display areas, and webpage contents and/or the titles corresponding to other display areas are hidden.

If the number of currently opened webpages is less than or equal to the number of display areas that are allowed to be displayed in the current window (the display threshold number), webpage contents and/or the titles corresponding to the all display areas are displayed respectively in the display areas.

In addition, if the number of currently opened webpages is greater than the number of webpages that are allowed to be displayed in the window (the display threshold number), the other display areas and the corresponding webpage contents are hidden. A terminal may receive a command that the user selects to display one of the hidden areas. Thus, the webpage content and/or the title corresponding to one of the display areas displayed in the current window is switched to the webpage content and/or the title corresponding to one of the hidden display areas.

Finally, when receiving a command that the user selects one display area, the webpage corresponding to the selected display area is displayed in the current window. Returning to FIG. 5, the method further includes the following steps:

Step 340: the browser receives a command that the user selects one display area.

Step 350: the browser displays entire webpage content corresponding to the selected display area in the current window and hides webpage contents corresponding to other display areas.

Corresponding to Step 340, a mapping relationship between the screenshot and the corresponding currently visited window may be created. Each window that is currently visited has rendered the webpage content. When the user clicks the screenshot, the browser may directly locate the window that is being visited currently through the mapping relationship and hide other display areas that are currently displayed and webpage content included in the screenshots of the display areas. A new current window is formed, displaying the entire webpage content corresponding to the selected display area for user to browse in a full screen mode. During this process, stretch, fly in, blinds and other animated effects may be set by related effects tabs. There are no specific limitations.

When a browser receives information that a user needs to switch a webpage displayed in the current window to browse other webpages, the browser obtains all currently opened webpages. Based on the number of webpages, multiple display areas are created for all currently opened webpages. The webpage content of each webpage that is visited is displayed through screenshot in normal, zoom out, or zoom in based on the scope of the display area. The method takes into account the imagery of webpage content and the efficiency of the webpage selection, improving the flexibility of the display scale. Thus, the user may quickly determine the window that needs to be browsed. After browsing webpage contents of the subwindows of the display areas, the user selects a display area. The browser receives the selection command. The browser then enlarges the display area to form a new current window and hides other display areas. The newly formed current window displays the webpage content with a normal size and area. Comparing to webpage selection by the list, the user may switch between windows more quickly and accurately based on webpage content rather than the title when using terminals with a small size screen or when the user has vision impairments. Comparing to webpage selection by sliding screen, the user does not need to repeat the operations when the webpages are not adjacent. A smooth loop interface with the current window-multiple windows-the new current window is formed, improving the efficiency for switching windows.

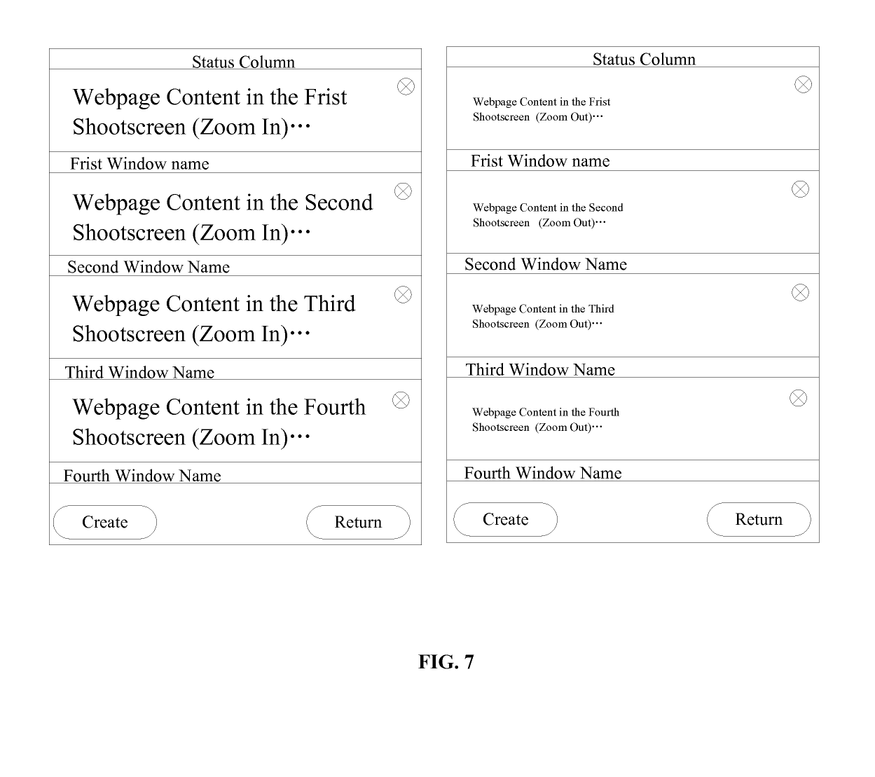

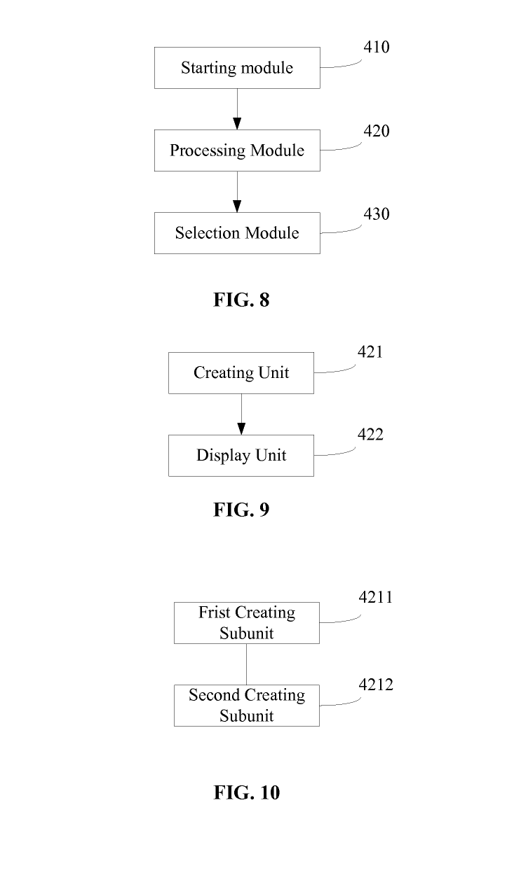

FIG. 8 illustrates a structure diagram of an exemplary window switching apparatus consistent with the disclosed embodiments. As shown in FIG. 8, the apparatus includes a starting module 410, a processing module 420, and a selection module 430.

The starting module 410 is configured to obtain all currently opened webpages when a browser receives information that a user needs to switch the webpage displayed in the current window.

The processing module 420 is configured to create multiple display areas for all currently opened webpages based on preset rules, and display the topic content of each webpage in the corresponding display area.

The selection module 430 is configured to display the webpage corresponding to the selected display area in the current window when the browser receives a command that the user selects to display one of the display areas.

FIG. 9 illustrates a structure diagram of an exemplary processing module consistent with the disclosed embodiments. As shown in FIG. 9, the processing module 420 further includes a creating unit 421 and a display unit 422.

The creating unit 421 is configured to create multiple display areas based on the number of all currently opened webpages. The display unit 422 is configured to display the topic content of each webpage in the corresponding display area in the current window based on preset rules.

FIG. 10 illustrates a structure diagram of an exemplary creating unit consistent with the disclosed embodiments. As shown in FIG. 10, the creating unit 421 further includes a first creating subunit 4211 and a second creating subunit 4212.

The first creating subunit 4211 is configured to, if the number of all currently opened webpages is greater than or equal to the number of display areas that are allowed to be displayed in the current window, divide horizontally/vertically the current window to obtain display specification of each display area based on the number of display areas that are allowed to be displayed in the current window and create the display areas based on the number of currently opened webpages and the display specification of each display area.

The second creating subunit 4212 is configured to, if the number of currently opened webpages is less than the number of display areas that are allowed to be displayed in the current window, divide horizontally/vertically the current window to obtain the display specification of each display area based on the number of currently opened webpages and create the display areas based on the number of currently opened webpages and the display specification of each display area.

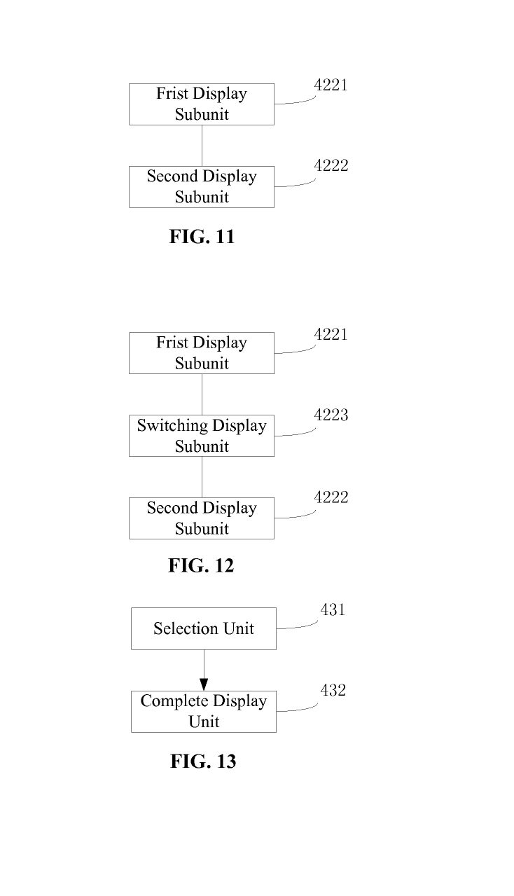

FIG. 11 illustrates a structure diagram of an exemplary display unit consistent with the disclosed embodiments. As shown in FIG. 11, the display unit 422 further includes a first display subunit 4221 and a second display subunit 4222.

The first display subunit 4221 is configured to, if the number of currently opened webpages is greater than the number of webpages that are allowed to be displayed in the window, display respectively webpage contents and/or titles corresponding to the display areas that are allowed to be displayed and hide webpage contents and/or titles corresponding to other display areas.

The second display subunit 4222 is configured to, if the number of all currently opened webpages is less than or equal to the number of display areas that are allowed to be displayed in the current window, display respectively webpage contents and/or the titles corresponding to the display areas.

FIG. 12 illustrates a structure diagram of another exemplary display unit consistent with the disclosed embodiments. As shown in FIG. 12, the display unit 422 further includes a switching display subunit 4223.

The switching display subunit 4223 is configured to receive a command that the user selects to display one of the hidden areas and switch the webpage content and/or the title corresponding to the display area displayed in the current window to the webpage content and/or the title corresponding to one of the hidden display areas.

FIG. 13 illustrates a structure diagram of an exemplary selection module consistent with the disclosed embodiments. As shown in FIG. 13, the selection module 430 further includes a selection unit 431 and a complete display unit 432.

The selection unit 431 is configured to receive a command that the user selects to display one of the display areas.

The complete display unit 432 is configured to display the entire webpage content corresponding to the selected display area in the current window and hide the webpage content corresponding to other display areas.

When the start module receives information that a user needs to switch the webpage displayed in the current window to browse other webpages, the browser obtains all currently opened webpages. Based on the number of webpages, multiple display areas are created by the processing module for all currently opened webpages. The webpage content of each webpage that is visited is displayed through the subwindow or the screenshot based on the scope of the display area. The apparatus takes into account the imagery of webpage content and the efficiency of the webpage selection, improving the flexibility of the display scale. Thus, the user may quickly determine the window that needs to be browsed. After browsing webpage contents of the subwindows of the display areas, the user selects a display area through the selection module. The browser receives the selection command. The browser then enlarges the display area to form a new current window and hides other display areas. The newly formed current window displays the webpage content with a normal size and area. Comparing to webpage selection by the list, the user may switch between windows more quickly and accurately based on the webpage content rather than the title when using terminals with a small size screen or when the user has vision impairments. Comparing to webpage selection by sliding screen, the user does not need to repeat the operations when the webpages are not adjacent. A smooth loop interface with the current window-multiple windows-the new current window is formed, improving the efficiency for switching windows.

It should be noted that, in the above apparatus for switching windows, each functional module framing is only for illustrative purposes. In practical applications, the above functions are implemented by different functional modules according to the needs. That is, the internal structure of the apparatus for switching windows is divided into different functional modules to complete all or part of the functions described above.

In addition, idea about the apparatus for switching windows provided in the above embodiment is the same as that of the above method for switching windows. The specific implementation of the apparatus may refer to the embodiments of the above method, which is not repeated here.

Those skilled in the art should understand that all or part of the steps in the above method may be executed by relevant hardware instructed by a program, and the program may be stored in a computer-readable storage medium such as a read only memory, a magnetic disk, a Compact Disc (CD), and so on.

The embodiments disclosed herein are exemplary only and not limiting the scope of this disclosure. Without departing from the spirit and scope of this invention, other modifications, equivalents, or improvements to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

By using the disclosed methods and apparatus for switching windows, when a browser receives information that a user needs to switch a webpage displayed in the current window, the browser obtains all currently opened webpages. Based on the number of webpages, multiple display areas are created for all currently opened webpages. Based on the scope of the display area, the webpage content of each webpage that is visited is partially displayed through the subwindow or the screenshot.

The method takes into account the imagery of webpage content and the efficiency of the webpage selection. Thus, the user may quickly determine the window that needs to be browsed. After browsing webpage contents of the subwindows of the display areas, the user selects a display area. The browser receives the selection command and enlarges the display area to form a new current window. Other display areas are hidden. The newly formed current window displays the webpage content in normal size and area. Comparing to webpage selection by the list, the user may switch between windows more quickly and accurately based on webpage content rather than the title when using terminals with small size screen or when the user has vision impairments. Comparing to webpage selection by sliding screen, the user does not need to repeat the operations when the webpages are not adjacent. A smooth loop interface with the current window-multiple windows-new current window is formed, improving the efficiency for switching windows.

What is claimed is:

1. A window switching method, comprising:
receiving, by the browser, information that a user needs to switch a webpage displayed in the current window;
obtaining, by the browser, all currently opened webpages;
creating, by the browser, multiple display areas for all currently opened webpages based on preset rules;
displaying, by the browser, topic content of each visible webpage in the corresponding display area in a current window;
receiving, by the browser, a command that the user selects one of the display areas; and
displaying, by the browser, the currently opened webpage corresponding to the selected display area in the current window.

2. The method according to claim 1, wherein creating multiple display areas for all currently opened webpages based on preset rules and displaying topic content of each visible webpage in the corresponding display area further includes:
creating the multiple display areas based on a total number of all currently opened webpages; and
displaying the topic content of each visible webpage in the corresponding display area in the current window based on the preset rules.

3. The method according to claim 2, wherein creating multiple display areas based on the total number of all currently opened webpages further includes:
when the number of currently opened webpages is greater than or equal to a number of display areas that are allowed to be displayed, dividing the current window horizontally based on a number of display areas that are allowed to be displayed;
when the number of currently opened webpages is less than the number of display areas that are allowed to be displayed, dividing the current window horizontally based on the number of currently opened webpages;
obtaining display specification of each display area; and
creating the multiple display areas based on the number of currently opened webpages and the obtained display specification of each display area, wherein the number of display areas that are created equals to the number of currently opened webpages.

4. The method according to claim 2, wherein displaying the topic content of each webpage in the corresponding display area in the current window based on preset rules further includes:
displaying respectively webpage contents and titles corresponding to the display areas that are allowed to be displayed in the display areas and hiding webpage contents and/or titles corresponding to other display areas when the number of currently opened webpages is greater than the number of display areas that are allowed to be displayed in the window; and
displaying respectively web contents and titles corresponding to the display areas when the number of currently opened webpages is less than or equal to the number of display areas that are allowed to be displayed.

5. The method according to claim 4, wherein displaying respectively webpage contents and titles corresponding to the display areas that are allowed to be displayed in the display areas and hiding webpage contents and titles corresponding to other display areas when the number of currently opened webpages is greater than the number of display areas that are allowed to be displayed in the window further includes:
receiving a command that the user selects to display one of the hidden areas; and
switching the webpage content and the title corresponding to one display area displayed in the current window to the webpage content and the title corresponding to one of the hidden display areas.

6. The method according to claim 1, wherein displaying the webpage corresponding to the selected display area in the current window further includes:
receiving a command that the user selects to display one display area;
displaying webpage content corresponding to the selected display area in the entire current window; and
hiding the webpage contents corresponding to other display areas.

7. A window switching apparatus, comprising:
a starting module configured to obtain all currently opened webpages when a browser receives information that a user needs to switch the webpage displayed in a current window;
a processing module configured to create multiple display areas for all currently opened webpages based on preset rules and to display topic content of each visible webpage in the corresponding display area; and
a selection module configured to display the currently opened webpage corresponding to the selected display area in the current window when the browser receives a command that the user selects one of the display areas.

8. The window switching apparatus according to claim 7, wherein the processing module further includes:
a creating unit configured to create the multiple display areas based on a total number of all currently opened webpages; and
a display unit configured to display the topic content of each visible webpage in the corresponding display area in the current window based on the preset rules.

9. The window switching apparatus according to claim 8, wherein the creating unit further includes:
a first creating subunit configured to, when the number of all currently opened webpages is greater than or equal to a number of display areas that are allowed to be displayed, divide horizontally the current window to obtain display specification of each display area based on the number of display areas that are allowed to be displayed in the current window and to create the multiple display areas based on the number of currently opened webpages and the obtained display specification of each display area; and
a second creating subunit configured to, when the number of currently opened webpages is less than a number of display areas that are allowed to be, divide horizontally the current window to obtain the display specification of each display area based on the number of currently opened webpages and to create the multiple display areas based on the number of currently opened webpages and the obtained display specification of each display area.

10. The window switching apparatus according to claim 8, wherein the display unit further includes:
a first display subunit configured to, when the number of currently opened webpages is greater than the number of webpages that are allowed to be displayed in the window, display respectively webpage contents and titles corresponding to the display areas that are allowed to be displayed and to hide webpage contents and titles corresponding to other display areas; and
a second display subunit configured to, when the number of all currently opened webpages is less than or equal to the number of display areas that are allowed to be displayed in the current window, display respectively the webpage contents and the titles corresponding to the display areas.

11. The window switching apparatus according to claim 8, wherein the display unit further includes:
a switching display subunit configured to receive a command that the user selects to display one of the hidden areas and switch the webpage content and the title corresponding to the display area displayed in the current window to the webpage content and the title corresponding to one of the hidden display areas.

12. The window switching apparatus according to claim 7, wherein the selection module further includes:
a selection unit configured to receive a command that the user selects one of the display areas; and
a complete display unit configured to display the webpage content corresponding to the selected display area in the entire current window and to hide the webpage contents corresponding to other display areas.

13. A non-transitory computer-readable medium having computer-executable program for, when being executed by a processor, performing a window switching method, the method comprising:
receiving information that a user needs to switch a webpage displayed in the current window;
obtaining all currently opened webpages;
creating multiple display areas for all currently opened webpages based on preset rules;
displaying topic content of each visible webpage in the corresponding display area in a current window;
receiving a command that the user selects one of the display areas; and
displaying the currently opened webpage corresponding to the selected display area in the current window.

14. The computer-readable medium according to claim 13, wherein creating multiple display areas for all currently opened webpages based on preset rules and displaying topic content of each visible webpage in the corresponding display area further includes:
creating the multiple display areas based on a total number of all currently opened webpages; and
displaying the topic content of each visible webpage in the corresponding display area in the current window based on the preset rules.

15. The computer-readable medium according to claim 14, wherein creating multiple display areas based on the total number of all currently opened webpages further includes:
when the number of currently opened webpages is greater than or equal to a number of display areas that are allowed to be displayed, dividing the current window horizontally based on a number of display areas that are allowed to be displayed;
when the number of currently opened webpages is less than the number of display areas that are allowed to be displayed, dividing the current window horizontally based on the number of currently opened webpages;
obtaining display specification of each display area; and
creating the multiple display areas based on the number of currently opened webpages and the obtained display specification of each display area, wherein the number of display areas that are created equals to the number of currently opened webpages.

16. The computer-readable medium according to claim 14, wherein displaying the topic content of each webpage in the corresponding display area in the current window based on preset rules further includes:
displaying respectively webpage contents and titles corresponding to the display areas that are allowed to be displayed in the display areas and hiding webpage contents and/or titles corresponding to other display areas when the number of currently opened webpages is greater than the number of display areas that are allowed to be displayed in the window; and
displaying respectively web contents and titles corresponding to the display areas when the number of currently opened webpages is less than or equal to the number of display areas that are allowed to be displayed.

17. The computer-readable medium according to claim 16, wherein displaying respectively webpage contents and titles corresponding to the display areas that are allowed to be displayed in the display areas and hiding webpage contents and titles corresponding to other display areas when the number of currently opened webpages is greater than the number of display areas that are allowed to be displayed in the window further includes:
receiving a command that the user selects to display one of the hidden areas; and
switching the webpage content and the title corresponding to one display area displayed in the current window to the webpage content and the title corresponding to one of the hidden display areas.

18. The computer-readable medium according to claim 13, wherein displaying the webpage corresponding to the selected display area in the current window further includes:
receiving a command that the user selects to display one display area;
displaying webpage content corresponding to the selected display area in the entire current window; and
hiding the webpage contents corresponding to other display areas.
